(19) United States
(12) Patent Application Publication
(10) Pub. No.: US 2017/0061480 A1
(43) Pub. Date: Mar. 2, 2017

(54) OPTIMIZING ACQUISITION CHANNELS BASED ON CUSTOMER LIFETIME VALUES

(71) Applicant: LinkedIn Corporation, Mountain View, CA (US)

(72) Inventors: Xing Zhou, Mountain View, CA (US); Juan Wang, Los Altos, CA (US); Zhaoying Han, Mountain View, CA (US); Qiang Zhu, Sunnyvale, CA (US); Hojeong Kim, Belmont, CA (US)

(73) Assignee: LINKEDIN CORPORATION, Mountain View, CA (US)

(21) Appl. No.: 14/841,507

(22) Filed: Aug. 31, 2015

(51) Int. Cl. G06Q 30/02

(52) U.S. Cl. CPC G06Q 30/0254; G06Q 30/0201

(57) ABSTRACT

The disclosed embodiments provide a system for processing data. During operation, the system obtains a set of features for a customer of a product. Next, the system uses the set of features to identify a likelihood of purchasing the product through a first channel by the customer and estimate a first customer lifetime value (CLV) for the customer through the first channel and a second CLV for the customer through a second channel. The system then selects an acquisition channel for the customer from the first and second channels based on the likelihood and the first and second CLVs. Finally, the system outputs a recommendation of the selected acquisition channel for use in marketing the product to the customer.

### BACKGROUND

Field

The disclosed embodiments relate to techniques for selecting marketing channels for customers. More specifically, the disclosed embodiments relate to techniques for optimizing marketing channels based on customer lifetime values.

Related Art

Social networks may include nodes representing entities such as individuals and/or organizations, along with links between pairs of nodes that represent different types and/or levels of social familiarity between the nodes. For example, two nodes in a social network may be connected as friends, acquaintances, family members, and/or professional contacts. Social networks may further be tracked and/or maintained on web-based social networking services, such as online professional networks that allow the entities to establish and maintain professional connections, list work and community experience, endorse and/or recommend one another, run advertising and marketing campaigns, promote products and/or services, and/or search and apply for jobs.

In turn, social networks and/or online professional networks may facilitate sales and marketing activities and operations by the entities. For example, sales and/or marketing professionals may use an online professional network to identify prospective customers, maintain professional images, establish and maintain relationships, and/or close sales deals. In addition, sales and marketing activities may be conducted through multiple acquisition channels in the social networks, which may differ in overhead and/or effectiveness. For example, prospective and/or current customers may be selected for targeting through online acquisition channels within the online professional network or field acquisition channels in which customers interact with sales and/or marketing professionals associated with the online professional network. While the field channel may produce more conversions than the online channel, the online channel may also be associated with higher profit margins and/or relatively unlimited resources when compared with the field channel.

Consequently, sales and/or marketing activities may be facilitated by mechanisms for optimizing acquisition channels for customers of a product.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a flowchart illustrating the process of estimating a customer lifetime value (CLV) for a customer through an acquisition channel in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

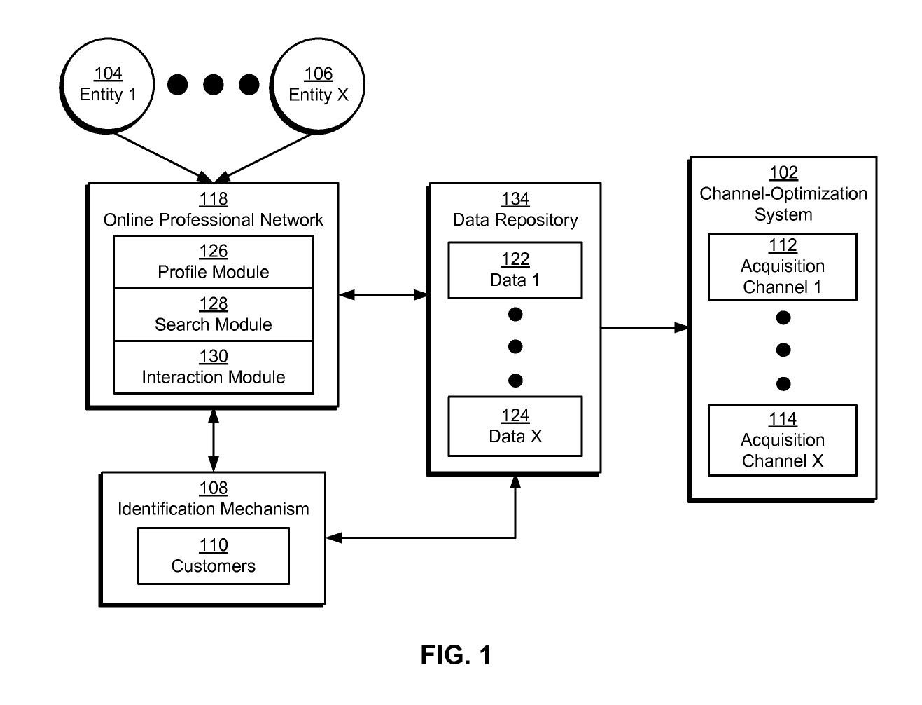

The disclosed embodiments provide a method, apparatus, and system for processing data. More specifically, the disclosed embodiments provide a method, apparatus, and system for optimizing acquisition channels based on customer lifetime values (CLVs) of customers in a social network. As shown in FIG. 1, the social network may be an online professional network 118 that allows a set of entities (e.g., entity 1104, entity x 106) to interact with one another in a professional and/or business context.

The entities may include users that use online professional network 118 to establish and maintain professional connections, list work and community experience, endorse and/or recommend one another, and/or search and apply for jobs. The entities may also include companies, employers, and/or recruiters that use online professional network 118 to list jobs, search for potential candidates, and/or provide business-related updates to users.

The entities may use a profile module 126 in online professional network 118 to create and edit profiles containing profile pictures, along with information related to the entities' professional and/or industry backgrounds, experiences, summaries, projects, and/or skills Profile module 126 may also allow the entities to view the profiles of other entities in online professional network 118.

Next, the entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature on online professional network 118 to search for profiles, jobs, and/or information by categories such as first name, last name, title, company, school, location, interests, relationship, industry, groups, salary, and/or experience level.

The entities may also use an interaction module 130 to interact with other entities on online professional network 118. For example, interaction module 130 may allow an entity to add other entities as connections, follow other entities, send and receive messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or newsfeed that provides the latest postings, articles, and/or updates from the entities' connections and/or groups to the entities. Similarly, online professional network 118 may include mechanisms for recommending connections, job postings, articles, and/or groups to the entities.

In one or more embodiments, data (e.g., data 1122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, and/or other action performed by an entity in online professional network 118 may be tracked and stored in a database, data warehouse, cloud storage, and/or other data-storage mechanism providing data repository 134.

The entities may also include a set of customers 110 that purchase products through online professional network 118. For example, customers 110 may include individuals and/or organizations with profiles on online professional network 118. As a result, customers 110 may use online professional network 118 to interact with professional connections, list and apply for jobs, establish professional brands, and/or conduct other activities in a professional and/or business context.

Customers 110 may also be targeted for marketing or sales activities by other entities in online professional network 118. For example, customers 110 may be companies that purchase business products and/or solutions that are offered by online professional network 118 to achieve goals related to hiring, marketing, advertising, and/or selling. In another example, customers 110 may be individuals and/or companies that are targeted by marketing and/or sales professionals through online professional network 118.

As shown in FIG. 1, customers 110 may be identified by an identification mechanism 108 using data from data repository 134 and/or online professional network 118. For example, identification mechanism 108 may identify customers 110 by matching profile data, group memberships, industries, skills, customer relationship data, and/or other data for customers 110 to keywords related to products that may be of interest to customers 110. As a result, customers 110 may include entities that have purchased products through and/or within online professional network 118, as well as entities that have not yet purchased but may be interested in products offered through and/or within online professional network 118.

Identification mechanism 108 may also match customers 110 to products using different sets of criteria. For example, identification mechanism 108 may match customers in recruiting roles to recruiting solutions, customers in sales roles to sales solutions, customers in marketing roles to marketing solutions, and customers in advertising roles to advertising solutions. If different variations of a solution are available, identification mechanism 108 may also identify the variation that may be most relevant to the customer based on the size, location, industry, and/or other attributes of the customer. In another example, products offered by other entities through online professional network 118 may be matched to current and/or prospective customers through criteria specified by the other entities. In a third example, customers 110 may include all entities in online professional network 118, which may be targeted with products such as “premium” subscriptions or memberships with online professional network 118.

After customers 110 are identified, a channel-optimization system or mechanism 102 may select an acquisition channel (e.g., acquisition channel 1 112, acquisition channel x 114) for use in targeting the marketing or sales of a given product to each customer. For example, channel-optimization system 102 may select an online channel or a field channel through which the customer is engaged to market or sell a recruiting, marketing, sales, and/or advertising solution. As described in further detail below, the acquisition channel may be selected based on the customer's likelihood of purchasing the product through the acquisition channel, as well as the customer's estimated customer lifetime value (CLV) for each potential acquisition channel. As with other data related to the entities and/or customers 110, the selected acquisition channel may then be stored in data repository 134 and/or another repository for subsequent retrieval and use.

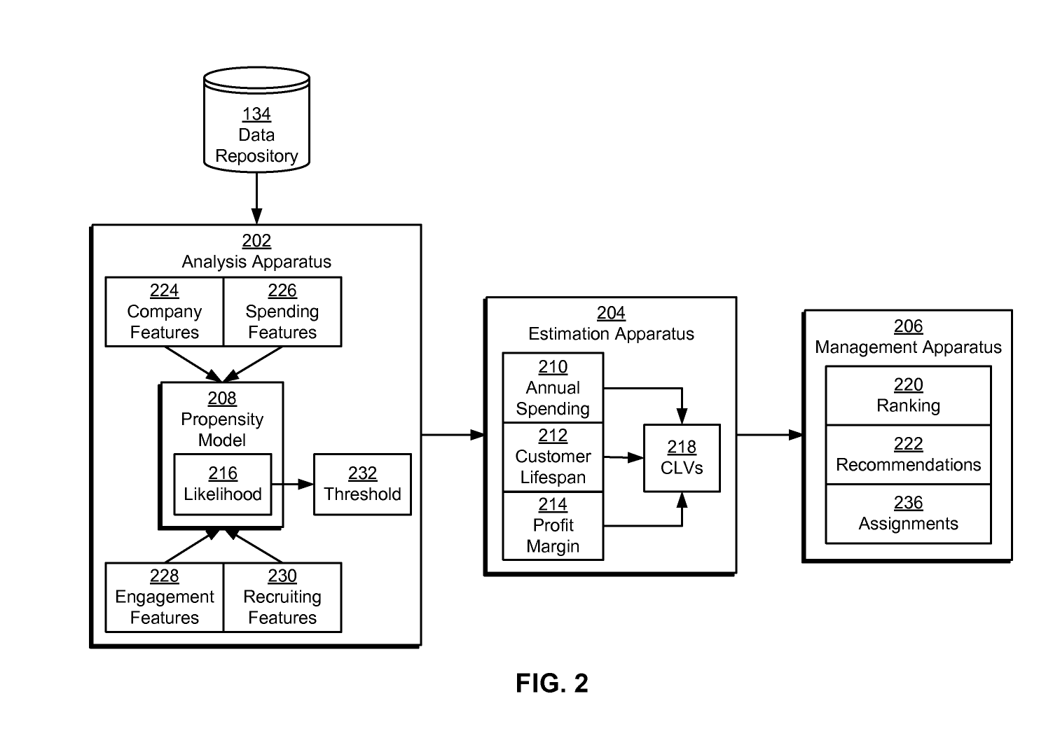

FIG. 2 shows a system for processing data in accordance with the disclosed embodiments. More specifically, FIG. 2 shows a system for optimizing the selection of acquisition channels for a number of customers (e.g., customers 110 of FIG. 1), such as channel-optimization system 102 of FIG. 1. As shown in FIG. 2, the system includes an analysis apparatus 202, an estimation apparatus 204, and a management apparatus 206. Each of these components is described in further detail below.

Analysis apparatus 202 may determine, for each customer, a likelihood 216 of purchasing a product. As described above, the customer may be a prospective customer that is identified using data from data repository 134. Analysis apparatus 202 may also use data from data repository 134 to generate a set of features for the customer, including one or more company features 224, one or more spending features 226, one or more engagement features 228, and one or more recruiting features 230. For example, analysis apparatus 202 may use one or more queries to obtain the features directly from data repository 134, extract one or more features from the queried data, and/or aggregate the queried data into one or more features.

Company features 224 may include attributes and/or metrics associated with a customer that is a company. First, company features 224 may include demographic attributes such as a location, an industry, an age, and/or a size of the company. Company features 224 may also include metrics associated with membership of the company's employees with an online professional network (e.g., online professional network 118 of FIG. 1), which may be used to gauge the participation level of the employees with the online professional network and/or the proportions of different types of employees in the company. For example, company features 224 may include a number of employees who are members of the online professional network, a number of employees at a certain level of seniority (e.g., entry level, mid-level, manager level, senior level, etc.) who are members of the online professional network, and/or a number of employees with certain roles (e.g., engineer, manager, sales, marketing, executive, etc.) who are members of the online professional network. Company features 224 may additionally include one or more metrics related to the operation of the company, such as a metric related to the size of a staffing department in the company.

Spending features 226 may be related to the spending behavior of the customer. For example, spending features 226 may include an “account interest score” that represents the customer's level of interest in the product. Spending features 226 may also include metrics related to the customer's historic and/or projected spending on one or more products (e.g., marketing solutions, sales solutions, talent solutions, etc.) offered through the online professional network.

Engagement features 228 may relate to the customer's level of engagement with the online professional network. For example, engagement features 228 may include a “talent brand index” that measures the popularity of the customer's brand. Engagement features 228 may also include metrics related to the customer's level of activity on the online professional network. Such metrics may measure the customer's search activity, such as the number of company searches, the number of people searches, and/or the number of total searches performed by the customer. The metrics may also represent other types of activity with the online professional network. For example, the metrics may include, for a given period (e.g., a day, a month, a year), the number of messages sent, profile views, profile updates, company updates, and/or visits to the online professional network by the customer. The metrics may additionally specify the number of connections and/or followers of the customer.

Recruiting features 230 may identify recruiting activity of the customer. For example, recruiting features 230 may include the number of recruiters, talent professionals (e.g., human resources staff), hires, hires by seniority and/or hires by industry for the customer's company. Recruiting features 230 may also include the number of job postings on the online professional network and/or job postings with other places by the customer within a given period.

After company features 224, spending features 226, engagement features 228, and recruiting features 230 are obtained, analysis apparatus 202 may identify likelihood 216 by inputting the features into a propensity model 208. Propensity model 208 may be a statistical model that calculates the propensity of the customer to purchase the product through a given acquisition channel based on the customer's features. For example, propensity model 208 may be a random forest that identifies the customer's propensity (e.g., likelihood 216) for purchasing a marketing, talent, and/or business solution through a field channel. The output of the random forest may include a discrete score (e.g., in increments of 0.1 from 0.0 to 1.0) representing the customer's likelihood 216 of converting to the product through the field channel.

Those skilled in the art will appreciate that propensity model 208 may be implemented using different techniques and/or used to calculate different types of likelihoods. For example, propensity model 208 may include artificial neural networks, Bayesian networks, support vector machines, clustering techniques, and/or other implementations of machine-learning techniques. Moreover, propensity model 208 may be adapted to predict likelihood 216 for different types of acquisition channels. For example, different versions of propensity model 208 may be used to identify the customer's likelihood 216 of converting to the product through an online channel, email channel, affiliate channel, and/or other type of acquisition channel. If multiple versions of propensity model 208 are available, the outputs from the versions may be combined and/or aggregated into one or more scores representing the customer's predicted behavior across all channels.

In one or more embodiments, analysis apparatus 202 applies a threshold 232 to likelihood 216 to select an acquisition channel for the customer. Threshold 232 may represent a pre-specified value of likelihood 216 and/or a pre-specified number of customers with the highest values of likelihood 216. For example, threshold 232 may be set to 0.8 so that customers with values of likelihood 216 that meet or exceed the threshold (e.g., customers with high propensity for converting through the corresponding acquisition channel) may be considered for assignment to the acquisition channel. Conversely, threshold 232 may represent a percentage and/or number of customers with the highest propensity (e.g., highest values of likelihood 216) for converting through the acquisition channel.

For each customer with a value of likelihood 216 that meets or exceeds threshold 232, estimation apparatus 204 may calculate a number of CLVs 218 for the customer, with each CLV representing a prediction of the revenue and/or profit from the entire future relationship with the customer through the corresponding acquisition channel. For example, estimation apparatus 204 may calculate two CLVs for the customer, including one for engagement through a field channel and one for engagement through an online channel.

As shown in FIG. 2, estimation apparatus 204 may combine an annual spending 210, a customer lifespan 212, and a profit margin 214 for the customer in a given acquisition channel into a CLV for the acquisition channel. First, estimation apparatus 204 may use a statistical model to estimate annual spending 210. For example, estimation apparatus 204 may use a regression technique to predict an annual dollar amount that will be spent by the customer in a given acquisition channel Like propensity model 208, features inputted into the statistical model may include company features 224 (e.g., company size, location, industry, etc.), spending features 226 (e.g., historic spending, estimated spending, potential spending, account interest score), engagement features 228 (e.g., number of company connections, number of total connections, number of messages sent, number of followers, talent brand index), recruiting features 230 (e.g., number of hires, number of senior hires, number of recruiters, etc.), and/or other features that are relevant to the customer's purchasing behavior through the online professional network.

Next, estimation apparatus 204 may calculate customer lifespan 212 for the customer. Customer lifespan 212 may include growth and/or churn factors that affect different segments of customers. For example, customer lifespan 212 may include one or more factors that represent the growth and/or churn of the customer based on acquisition channel and the size, location, and/or industry of the company represented by the customer. The factors may be calculated by aggregating historic spending data for different company segments and acquisition channels.

Estimation apparatus 204 may then identify profit margin 214 for the customer. As with customer lifespan 212, profit margin 214 may have different values for different company segments and/or acquisition channels. For example, profit margin 214 for an online channel may be higher than profit margin 214 for a field channel because of the additional overhead associated with human interaction in the field channel. Within the field channel, profit margin 214 may be higher for larger companies and lower for smaller companies because larger companies tend to spend more than smaller companies.

After annual spending 210, customer lifespan 212, and profit margin 214 are calculated and/or selected for the customer in a given acquisition channel, estimation apparatus 204 may calculate a CLV for the customer in the acquisition channel. For example, estimation apparatus 204 may multiply annual spending 210 by customer lifespan 212 and profit margin 214 to obtain the CLV. Estimation apparatus 204 may optionally apply other formulas, weights, and/or factors in the calculation of CLVs 218, annual spending 210, customer lifespan 212, and/or profit margin 214. For example, estimation apparatus 204 may use one or more additional statistical models to calculate CLVs 218, customer lifespan 212, and/or profit margin 214 for the customer.

Finally, management apparatus 206 may use likelihood 216 and/or CLVs 218 to generate a ranking 220 of customers. For example, management apparatus 206 may rank the customers by likelihood 216 of purchasing the product through an acquisition channel and/or by CLV through the acquisition channel. Management apparatus 206 may display the ranking in a user interface and/or enable filtering of the ranking by industry, company size, location, and/or other attributes.

Management apparatus 206 may also generate a set of recommendations 222 for the customers. Recommendations 222 may represent selections of acquisition channels for the customers based on ranking 220, CLVs 218, and/or likelihood 216. As with calculation of likelihood 216 and CLVs 218, different criteria and/or formulas may be used and/or combined to generate recommendations 222.

For example, management apparatus 206 may select a field channel for a customer if the customer's likelihood 216 of converting through the field channel is higher than threshold 232 and the customer's CLV in the field channel is higher than the customer's CLV in other acquisition channels. If likelihood 216 does not exceed threshold 232 and/or the CLV for the field channel is not higher than the CLV for another acquisition channel (e.g., an online channel), the other acquisition channel may be selected because customer engagement through the field channel may be associated with limited resources (e.g., sales or marketing representatives). In another example, management apparatus 206 may multiply likelihood 216 of converting through each acquisition channel with the corresponding CLV for the acquisition channel to obtain an “expected” CLV for the acquisition channel and assign the customer to the acquisition channel with the highest “expected” CLV. In a third example, management apparatus 206 may apply another threshold to CLVs 218 so that customers with CLVs 218 in a given acquisition channel that are higher than the threshold are selected for engagement through the acquisition channel.

Management apparatus 206 may additionally generate a set of assignments 236 based on ranking 220 and/or recommendations 222. For example, assignments 236 of customers selected for the field channel to different sales and/or marketing professionals may be generated so that customers that are most likely to convert and/or that are associated with the highest CLVs in the field channel may be targeted by the most effective sales and/or marketing professionals. Assignments 236 may also be made so that customers in different segments (e.g., industries, sizes, locations, etc.) are assigned to sales and/or marketing professionals with expertise in marketing or selling products to those segments.

Finally, management apparatus 206 may establish and/or enable communication with the customers based on recommendations 222 and/or assignments 236. For example, management apparatus 206 may generate one or communications through an online channel and transmit the communications to a customer selected for targeting through the online channel. Management apparatus 206 may also select the form of the communications (e.g., email, messages, advertisements, notifications, etc.) and/or content in the communications based on the size, location, industry, and/or other segment of the customer. Alternatively, if the customer is selected for targeting through the field channel, management apparatus 206 may provide demographic, spending, behavioral, and/or contact information (e.g., from data repository 134) for the customer to the sales and/or marketing professional with which the customer is matched to facilitate engagement with the customer by the sales and/or marketing professional. Consequently, the system of FIG. 2 may improve sales of products through the online professional network by targeting customers through the most effective acquisition channels while allocating limited resources in certain acquisition channels (e.g., field channels) in a way that produces the most effective results.

Those skilled in the art will appreciate that the system of FIG. 2 may be implemented in a variety of ways. First, analysis apparatus 202, estimation apparatus 204, management apparatus 206, and/or data repository 134 may be provided by a single physical machine, multiple computer systems, one or more virtual machines, a grid, one or more databases, one or more filesystems, and/or a cloud computing system. Analysis apparatus 202, estimation apparatus 204, and management apparatus 206 may additionally be implemented together and/or separately by one or more hardware and/or software components and/or layers.

Second, company features 224, spending features 226 engagement features 228, and recruiting features 230 may be obtained from a number of data sources. For example, data repository 134 may include data from a cloud-based data source such as a Hadoop Distributed File System (HDFS) that provides regular (e.g., hourly) updates to data associated with connections, people searches, and/or profile views. Data repository 134 may also include data from an offline data source such as a Structured Query Language (SQL) database, which refreshes at a lower rate (e.g., daily) and provides data associated with profile content (e.g., profile pictures, summaries, education and work history) and/or profile completeness.

Finally, a number of techniques may be used to generate likelihood 216, annual spending 210, customer lifespan 212, profit margin 214, CLVs 218, and/or other values used to optimize acquisition channels for the customers. As mentioned above, one or more statistical models may be used to estimate the values, or the values may be calculated from historic data. The statistical models may further be updated based on subsequent behavior and/or spending by the customers. For example, conversions, spending amounts, and/or other attributes associated with customers assigned to each acquisition channel may be tracked after the customers are engaged through the acquisition channel. The attributes may then be provided as training data to propensity model 208 and/or other statistical models, and the training data may be used to update weights, thresholds, and/or other elements used by the statistical models to calculate likelihood 216 and/or other values.

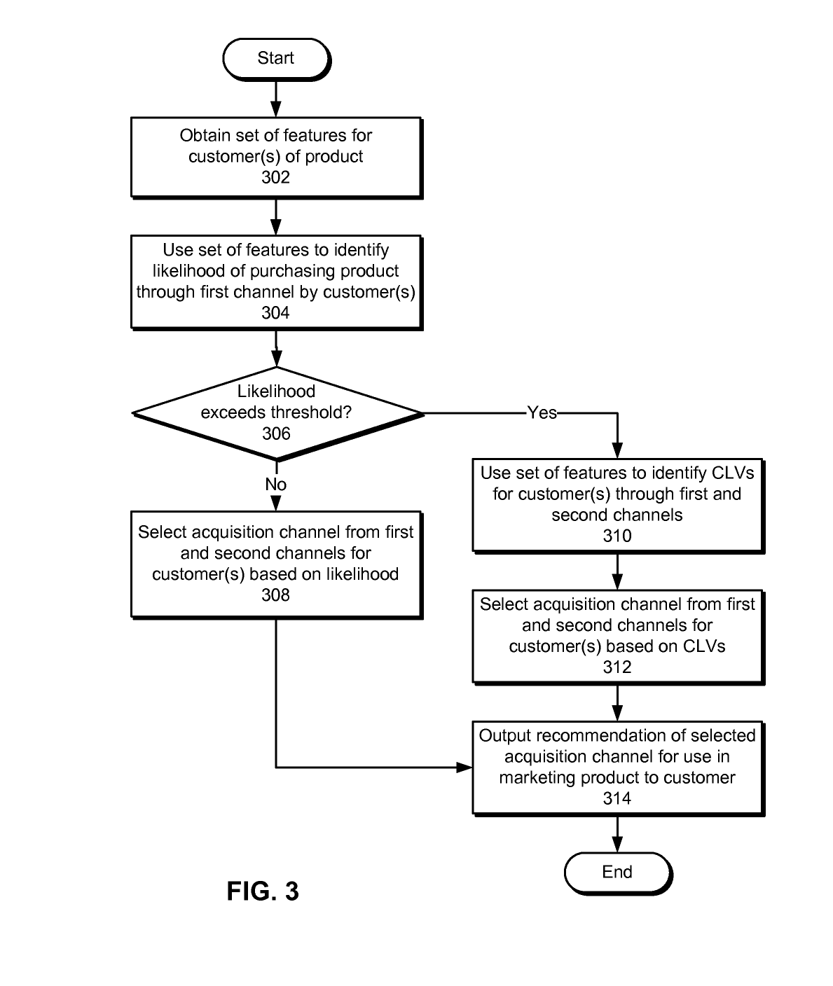

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a set of features for one or more prospective customers of a product is obtained (operation 302). For example, features for a company in an online professional network may include company features (e.g., brand score, industry, number of employees, number of employees at a level of seniority, etc.) and spending features (e.g., a level of interest in the product, a spending amount, etc.). The features may also include engagement features (e.g., number of searches, number of profile views, number of visits to an online professional network, number of followers, number of connections, number of profile updates, number of messages, etc.) and/or recruiting features (e.g., number of recruiters, number of talent professionals, number of hires, number of hires by seniority, number of hires by industry, number of job postings, etc.).

Next, the features are used to identify the likelihood of purchasing the product through a first channel by the customer(s) (operation 304). For example, the features for each customer may be inputted into a propensity model such as a random forest, and the propensity model may be used to obtain the customer's likelihood of purchasing the product through the first channel.

The likelihood may exceed a threshold (operation 306). For example, the likelihood may exceed a numeric threshold representing a minimum propensity for purchasing the product through the first channel. Alternatively, a set of customers may be ranked in descending order of likelihood of purchasing the product through the first channel, and the threshold may represent a pre-specified number (e.g., 50, 100, 1000) of the highest-ranked customers. If the likelihood does not exceed the threshold for a particular customer, an acquisition channel for the customer is selected from the first channel and a second channel based on the likelihood (operation 308). For example, if the customer's likelihood of purchasing the product through a field channel does not exceed the threshold, an online channel may be selected for the user to reserve limited field channel resources for targeting of customers with higher likelihood of purchasing the product through the field channel.

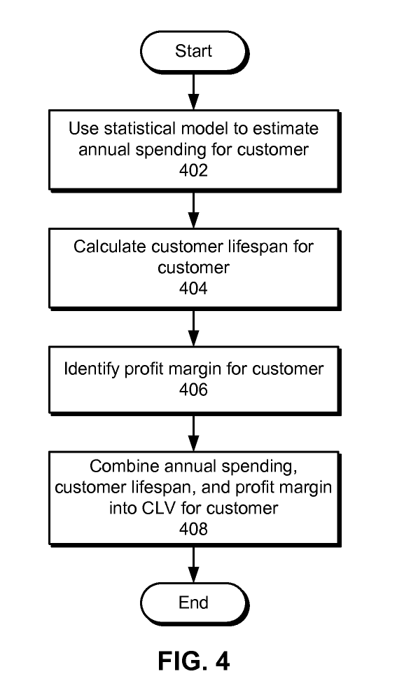

If the likelihood exceeds the threshold, the set of features is used to identify CLVs for the customer(s) through the first and second channels (operation 310), as discussed in further detail below with respect to FIG. 4. For example, CLVs may be calculated for a field channel, an online channel, and/or other acquisition channels through which the customer(s) may be engaged. A given acquisition channel may then be selected for the customer(s) based on the CLVs (operation 312). For example, the acquisition channel with the higher CLV from the online and field channels may be selected as the acquisition channel for the customer, up to a pre-specified number of customers for an acquisition channel with limited resources (e.g., field channel). If a given acquisition channel can only accommodate a limited number of customers, a set of customers with the highest CLVs and/or likelihoods for the acquisition channel may be assigned to the acquisition channel to further optimize the distribution of customers among multiple acquisition channels.

Finally, a recommendation of the selected acquisition channel is outputted for use in marketing the product to the customer (operation 314). For example, the selected acquisition channel may be displayed in a user interface with identifying information for the customer and/or stored with data for the customer in a data repository (e.g., data repository 134 of FIG. 1). Additional data that may be displayed and/or stored with the acquisition channel may include the customer's likelihood of purchasing the product through the acquisition channel, the customer's estimated annual spending through the acquisition channel, and/or the customer's CLV through the acquisition channel.

FIG. 4 shows a flowchart illustrating the process of estimating a CLV for a customer through an acquisition channel in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, a statistical model is used to estimate an annual spending for the customer (operation 402). For example, a regression technique may be used to estimate the customer's annual spending from a set of features, such as the company features, recruiting features, spending features, and/or engagement features described above.

Next, a customer lifespan is calculated for the customer (operation 404). For example, the customer lifespan may include one or more numeric factors that represent the growth and/or churn of the customer over time. The factors may be calculated from historic data for a given company segment, which may include the size, industry, location, and/or other attributes of the customer. A profit margin for the customer is also identified (operation 406). For example, the profit margin for the acquisition channel may be selected based on the industry, size, location, and/or other attributes of the customer.

The annual spending, customer lifespan, and profit margin are then combined into the CLV for the customer (operation 408). For example, the annual spending, customer lifespan, and profit margin may be multiplied to obtain the CLV. Additional weights and/or factors may also be included in the calculation of CLV. For example, the CLV may be multiplied by the customer's likelihood of purchasing the product through the acquisition channel to obtain an “expected CLV” for the customer.

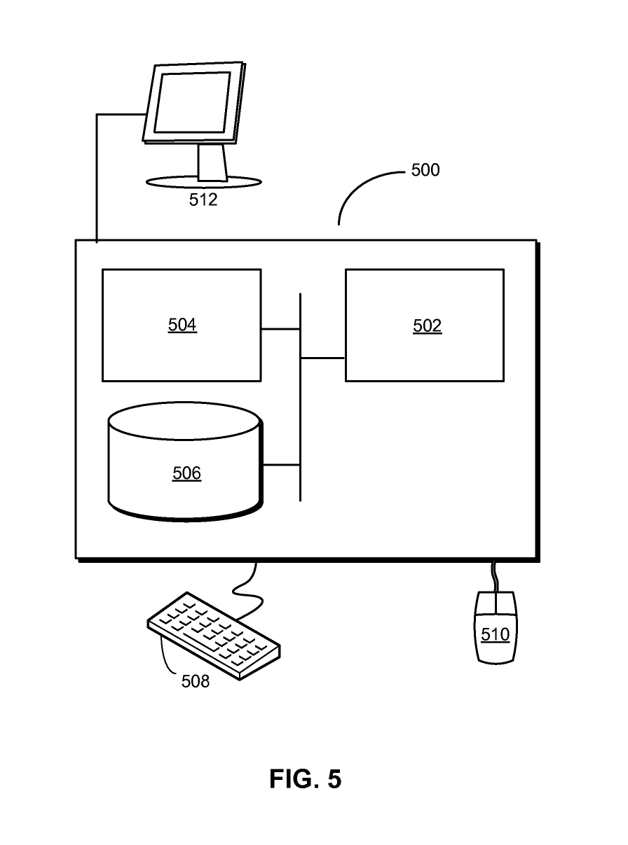

FIG. 5 shows a computer system 500. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system may include an analysis apparatus that obtains a set of features for a customer of a product and uses the set of features to identify a likelihood of purchasing the product through a first channel by the customer. The system may also include an estimation apparatus that uses the features to estimate a first CLV for the customer through the first channel and a second CLV for the customer through a second channel. The system may further include a management apparatus that selects an acquisition channel from the first and second channels for the customer based on the likelihood and the first and second CLVs. The management apparatus may then output a recommendation of the selected acquisition channel for use in marketing the product to the customer.

In addition, one or more components of computer system 500 may be remotely located and connected to the other components over a network. Portions of the present embodiments (e.g., analysis apparatus, estimation apparatus, management apparatus, data repository, etc.) may also be located on different nodes of a distributed system that implements the embodiments. For example, the present embodiments may be implemented using a cloud computing system that optimizes acquisition channels for use in marketing and selling products to a set of remote customers.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a set of features for a customer of a product;
using the set of features to identify, by one or more computer systems, a likelihood of purchasing the product through a first channel by the customer;
using the set of features to estimate, by the one or more computer systems, a first customer lifetime value (CLV) for the customer through the first channel and a second CLV for the customer through a second channel;
selecting, by the one or more computer systems, an acquisition channel for the customer from the first and second channels based on the likelihood and the first and second CLVs; and
outputting, by the one or more computer systems, a recommendation of the selected acquisition channel for use in marketing the product to the customer.

2. The method of claim 1, further comprising:
verifying that the likelihood of purchasing the product through the first channel by the customer exceeds a threshold prior to using the statistical model to estimate the first and second CLVs.

3. The method of claim 1, wherein using the set of features to identify the likelihood of purchasing the product through the first channel by the customer comprises:
inputting the set of features into a propensity model; and
using the propensity model to estimate the likelihood of purchasing the product through the first channel.

4. The method of claim 1, wherein estimating the first and second CLVs comprises:
using a statistical model to estimate an annual spending for the customer;
calculating a customer lifespan for the customer;
identifying a profit margin for the customer; and
combining the annual spending, the customer lifespan, and the profit margin into a CLV for the customer.

5. The method of claim 1, wherein selecting the acquisition channel for the customer from the first and second channels based on the likelihood and the first and second CLVs comprises:
upon verifying that the likelihood exceeds a threshold, selecting the acquisition channel with a higher CLV from the first and second CLVs for the customer.

6. The method of claim 1, wherein the set of features comprises:
a company feature;
a spending feature; and
an engagement feature.

7. The method of claim 6, wherein the company feature is at least one of:
a brand score;
an industry;
a number of employees; and
a number of employees at a level of seniority.

8. The method of claim 6, wherein the spending feature is at least one of:
a level of interest in the product; and
a spending amount.

9. The method of claim 6, wherein the engagement feature is at least one of:
a number of searches;
a number of profile views;
a number of visits to an online professional network;
a number of followers;
a number of connections;
a number of profile updates; and
a number of messages.

10. The method of claim 6, wherein the set of features further comprises a recruiting feature.

11. The method of claim 1, wherein the first and second channels comprise:
a field channel; and
an online channel.

12. The method of claim 1, wherein the product is associated with use of an online professional network.

13. An apparatus, comprising:
one or more processors; and
memory storing instructions that, when executed by the one or more processors, cause the apparatus to:
obtain a set of features for a customer of a product;
use the set of features to identify a likelihood of purchasing the product through a first channel by the customer;
use the set of features to estimate a first customer lifetime value (CLV) for the customer through the first channel and a second CLV for the customer through a second channel;
select an acquisition channel for the customer from the first and second channels based on the likelihood and the first and second CLVs; and
output a recommendation of the selected acquisition channel for use in marketing the product to the customer.

14. The apparatus of claim 13, wherein the memory further stores instructions that, when executed by the one or more processors, cause the apparatus to:
verify that the likelihood of purchasing the product through the first channel by the customer exceeds a threshold prior to using the statistical model to estimate the first and second CLVs.

15. The apparatus of claim 13, wherein using the set of features to identify the likelihood of purchasing the product through the first channel by the customer comprises:
inputting the set of features into a propensity model; and
using the propensity model to estimate the likelihood of purchasing the product through the first channel.

16. The apparatus of claim 13, wherein estimating the first and second CLVs comprises:
using a statistical model to estimate an annual spending for the customer;
calculating a customer lifespan for the customer;
identifying a profit margin for the customer; and
combining the annual spending, the customer lifespan, and the profit margin into a CLV for the customer.

17. The apparatus of claim 13, wherein selecting the acquisition channel for the customer from the first and second channels based on the likelihood and the first and second CLVs comprises:
upon verifying that the likelihood exceeds a threshold, selecting the acquisition channel with a higher CLV from the first and second CLVs for the customer.

18. The apparatus of claim 13, wherein the set of features comprises:
a company feature;
a spending feature; and
an engagement feature.

19. A system, comprising:
an analysis non-transitory computer-readable medium comprising instructions that, when executed by one or more processors, cause the system to:
obtain a set of features for a customer of a product; and
use the set of features to identify a likelihood of purchasing the product through a first channel by the customer;
an estimation non-transitory computer-readable medium comprising instructions that, when executed by one or more processors, cause the system to use the set of features to estimate a first customer lifetime value (CLV) for the customer through the first channel and a second CLV for the customer through a second channel; and
a management non-transitory computer-readable medium comprising instructions that, when executed by one or more processors, cause the system to:
select an acquisition channel for the customer from the first and second channels based on the likelihood and the first and second CLVs; and
output a recommendation of the selected acquisition channel for use in marketing the product to the customer.

20. The non-transitory computer-readable storage medium of claim 19, wherein the set of features comprises:
a company feature;
a spending feature;
an engagement feature; and
a recruiting feature.
